(19) United States
(12) Patent Application Publication
(10) Pub. No.: US 2022/0176985 A1
(43) Pub. Date: Jun. 9, 2022

(54) EXTRAVEHICULAR AUGMENTED REALITY

(71) Applicant: Rivian IP Holdings, LLC, Plymouth, MI (US)

(72) Inventors: Jeffrey M. Ota, Morgan Hill, CA (US); Steven T. Holmes, Redwood City, CA (US); Chun Yeung, Cupertino, CA (US); Robert J. Scaringe, Laguna Beach, CA (US)

(21) Appl. No.: 17/112,042

(22) Filed: Dec. 4, 2020

(51) Int. Cl. B60W 60/00; G01C 21/34; B60K 35/00; G01C 21/00; B64C 39/02

(52) U.S. Cl. CPC B60W 60/001; G01C 21/3407; B60K 35/00; G01C 21/3826; B64C 39/024; B64C 2201/123; B60K 2370/166; B60W 2420/52; B60W 2420/54; B60W 2420/42; B60K 2370/1529

(57) ABSTRACT

Various disclosed embodiments include illustrative navigation systems, and vehicles. A navigation system includes at least one sensor configured to detect terrain and objects near a vehicle and a processor configured to receive information from the at least one sensor and configured to determine a navigation path for the vehicle to follow. The navigation system also includes a projection system disposable on the vehicle. The projection system may be configured to project light onto at least one item chosen from terrain and objects based on the determined navigation path.

### INTRODUCTION

The present disclosure relates to navigating terrain for vehicles

The statements in this section merely provide background information related to the present disclosure and may not constitute prior art.

One of the great joys of having a vehicle which is configured to take on all terrains is taking the vehicle off-road where there may be no markers, roadways, pathways, etc and even if there are there still may be many hazards and obstacles. Although off-roading may be fun it may also be hazardous to the vehicle or its driver and passengers. Also, in off-roading it may be difficult to find one's way having to navigate, avoid, go around, or traverse hazards and obstacles. There are no maps which indicate where most of these hazards and obstacles are and some are continuously changing, such as swelling of rivers, recently fallen trees, fallen boulders, etc. Accordingly, the changing landscape in an off-road environment makes traversing the environment challenging.

### BRIEF SUMMARY

Various disclosed embodiments include sensor, mapping, navigation and augmented reality projection systems.

In an illustrative embodiment, a navigation system includes at least one sensor configured to detect terrain and objects near a vehicle and a processor configured to receive information from the at least one sensor and configured to determine a navigation path for the vehicle to follow. The navigation system also includes a projection system disposable on the vehicle. The projection system may be configured to project light onto at least one item chosen from terrain and objects based on the determined navigation path.

In another illustrative embodiment, a vehicle includes a vehicle body and at least one wheel coupled to the vehicle body and configured to be driven by at least one motor. The vehicle also includes at least one sensor configured to detect terrain and objects near the vehicle and a processor configured to receive information from the at least one sensor and configured to determine a navigation path for the vehicle to follow. Further, the vehicle includes a projection system disposed on the vehicle, the projection system being configured to project light onto at least one item chosen from the terrain and the objects based on the determined navigation path.

In another illustrative embodiment, a method of guiding a vehicle includes receiving, by the vehicle, data from sensors that are configured to detect terrain and objects near the vehicle. The method also includes building a navigation map based at least in part on the data and generating a driveable path for the vehicle based on the navigation map. Further, the method includes projecting light from the vehicle onto at least one item chosen from terrain and objects based on the driveable path.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

Illustrative embodiments are illustrated in referenced figures of the drawings. It is intended that the embodiments and figures disclosed herein are to be considered illustrative rather than restrictive.

FIG. 1 is a schematic diagram of a vehicle in relation to a mapping of pathways through off-road terrain.

FIG. 2 is a schematic diagram of a vehicle detecting obstacles and projecting light thereon.

FIG. 3 is a block diagram representing hardware and software systems used to implement various illustrative embodiments.

FIG. 4 is a flow diagram of a method according an illustrative embodiment.

Like reference symbols in the various drawings generally indicate like elements.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

Various disclosed embodiments include illustrative sensors, mapping, navigation and augmented reality projection systems.

It will be appreciated that various disclosed navigation systems enable vehicles to traverse difficult and ever-changing terrain while being able to identify and enhance obstacles and pathways for the vehicle.

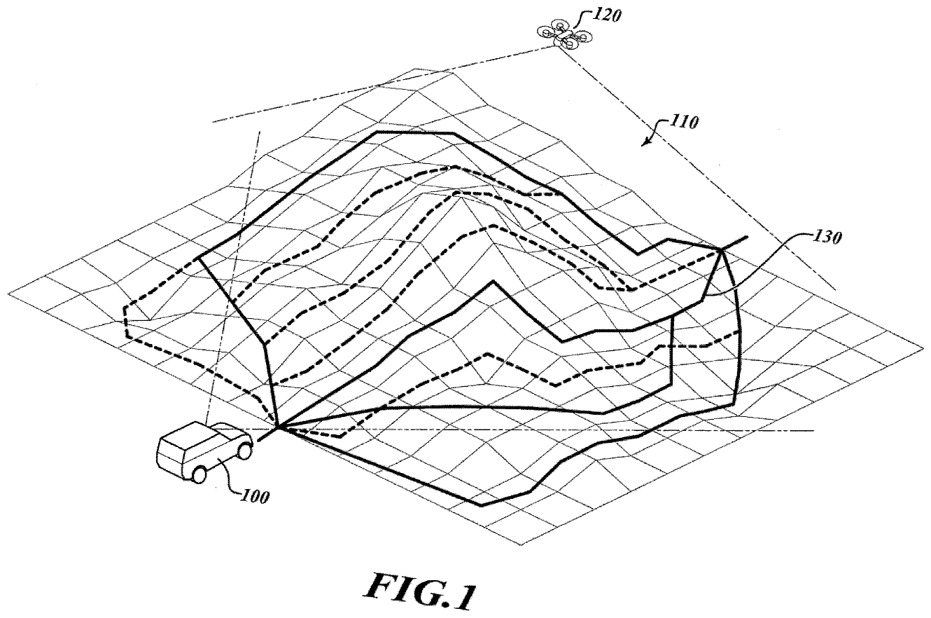

Referring now to FIG. 1, a vehicle 100, which may be any of a variety of vehicles including electric vehicles, internal combustion engine vehicles, hybrid vehicles, etc. including all types such as but not limited to cars, pickup trucks, vans, sports utility vehicles (SUVs), all-wheel drive vehicles, two-wheel drive vehicles, tracked vehicles, etc., may be used for off-road adventures. The vehicle 100 is depicted showing a map 110 of a terrain. The map 110 is depicted with a UAV 120 whose on board sensors (RADAR, Cameras, etc.) which may be partially responsible for the generation of the map 110 along with other information sources such as but not limited to map databases and Global Positioning System (GPS) sensors which may be on board the vehicle 100. The map 110 may have terrain and obstacles which make certain routes passable for example the routes 130 shown in solid line or routes that are more difficult or impossible to pass 140 shown in dashed lines. In various embodiments the map 110 may be displayed to a driver or passenger of the vehicle 100. The display may be a map display inside the cabin, a handheld display such as a tablet, portable computer, or mobile phone, etc. The routes 130 and 140, here represented as solid lines and dashed lines, may be displayed using other symbolic representations or may be displayed using different colors or a combination thereof.

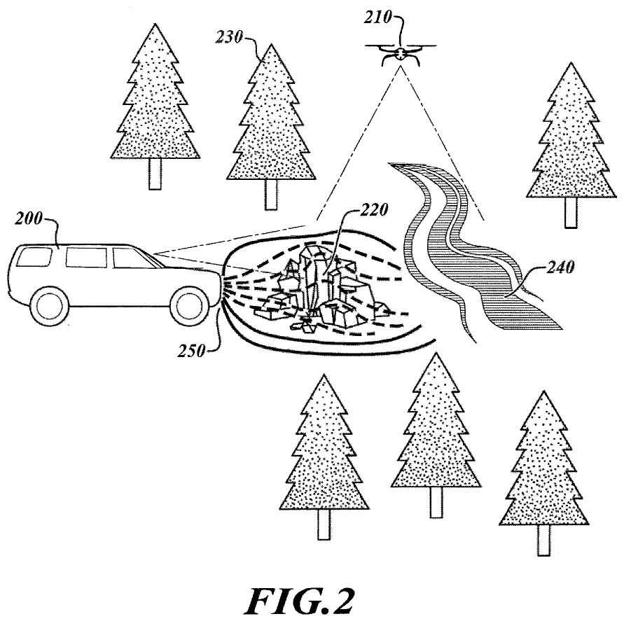

Referring now to FIG. 2, a vehicle 200 is depicted traversing off-road terrain. Vehicle 200 may be using a navigational system that follows or provides directions to follow various pathways, such as those depicted in FIG. 1. Even if the vehicle 200 follows a pathway that was deemed as passable, such as pathways 130, there may be obstacles that the vehicle 200 needs to be aware of either to use caution when traversing or to avoid. In various illustrative embodiments, a UAV 210 may be flying overhead and identifying hazards or obstacles such as but not limited to boulders 220, trees 230, waterways 240, or any of a variety of other hazards or obstacles. The UAV 210 may be carry sensors that can identify such objects or hazards in the path of vehicle 200 and communicate the location to systems on board vehicle 200. Alternatively sensors on board the vehicle 200 may also be used. These on board sensors may include but are not limited to cameras, LiDAR, RADAR, ultrasound, GPS, Accelerometers, Gyroscopes, magnetometers, etc. The output of these on-board and external sensors may be used to model a three-dimensional (3D) map of the environment near the vehicle 200. In some instances, the generated 3D environment may include obstacles such as boulder 220 which are in the path of the vehicle 200. As the vehicle 200 approaches obstacle 220, a light generation assembly 250, such as an aimable laser system 250. When an obstacle is identified, it may be automatically lit up by laser system 250. For example, colors may be used to identify certain risk, for example the boulders 220 may be indicated as red in color to indicate not to go there. The laser system 250 may also be used to identify pathways to travel, such as by lighting them up as green, meaning safe to travel, or yellow meaning use caution in travelling that route.

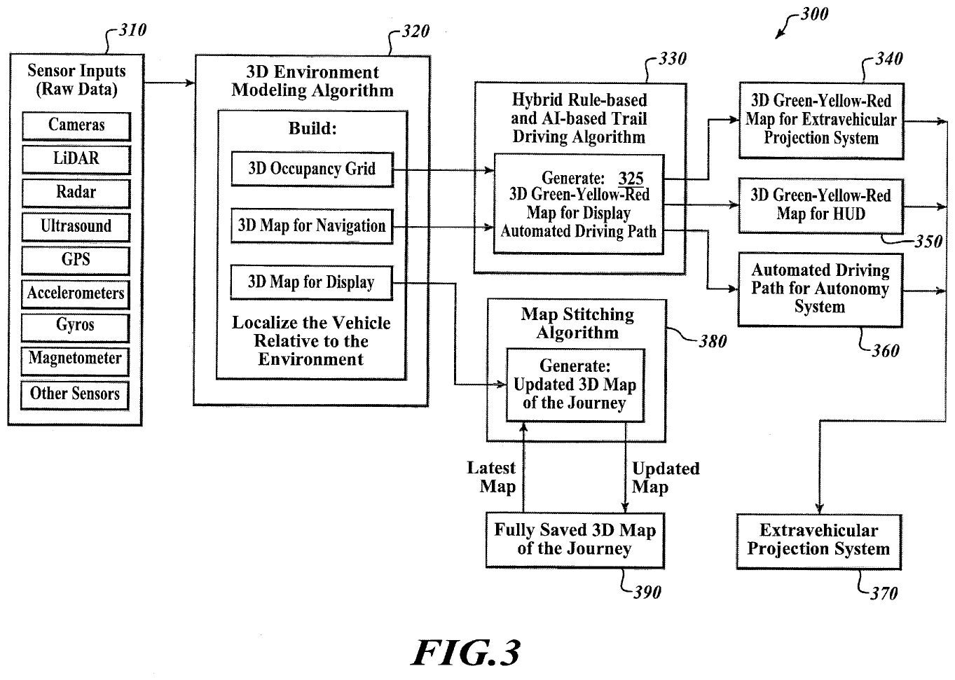

Referring now to FIG. 3, a block diagram of an illustrative navigation system 300, configured to detect terrain and objects near a vehicle, is depicted. The navigation system 300 may include at least one sensor 310, which may be any of a variety of sensors either on board the vehicle or some on board the vehicle while others external the vehicle. Sensors 310 may provide information to a processor that is configured to receive information from the sensors 310 and are configured to determine a navigation path for the vehicle to follow. Processor 320 uses a 3D environment modeling algorithm. The modeling algorithm may build multiple models for example without limitation a 3D Occupancy grid, a 3D map for Navigation, a 3D map for display. The modeling algorithms running on the processor 320 are configured to localize the vehicle relative to the environment. In accordance with various embodiments, a hybrid rule-based and artificial intelligence (AI) based trail driving algorithm 330 may, for example, be configured to generate a 3D map for automatically generating a driving path. Such driving path may be identified in the model by green (relatively safe driving), yellow (use caution), and red (do not drive). This 3D Green-Yellow-Red Map may be used to generate a 3D Green-Yellow-Red Map for an extravehicular projection system 340 which is used to identify hazards within the environment and then to use an extravehicular projection system 370, such as a steerable laser system may be used to light up physical objects in the environment. In accordance with various embodiments, the trail driving algorithm 330 may also be used to develop a 3D Green-Yellow-Red map 350 for use on a heads up display (HUD). Such a map is displayed on a HUD and can display to a driver obstacles which should be avoided. The HUD may use augmented reality (AR) in which the HUD is see-through and various things in the environment may be seen as part of the HUD map. Also , the system may display visual information that appears to become part of the environment. Similarly, from trail driving algorithm 330, an automated driving path 360 may be generated. This driving path may be used for an automated or autonomous driving system 360 to follow. In accordance with various embodiments the modeling algorithm 320 may be used to generate a 3D map that is used for display which is provided to a map stitching algorithm 380 that may be used generate an updated 3D map of the journey. A fully saved 3D map of the entire journey is stored 390.

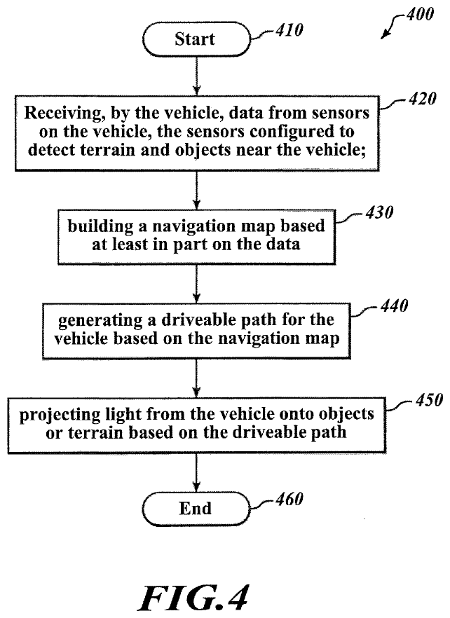

Referring now to FIG. 4, a method of guiding a vehicle 400 is started at a START block 410. The method 400 includes, at a block 420, receiving, by the vehicle, data from sensors on the vehicle, the sensors configured to detect terrain and objects near the vehicles. At a block 430, method 400 includes building a navigation map based at least in part on the data. At a block 440 method 400 includes generating a driveable path for the vehicle based on the navigation map. Further, at a block 450, method 400 includes projecting light from the vehicle onto at least one item chosen from the terrain and the objects based on the driveable path.

Referring again to FIG. 3, various sensors 310 may be used to in various configurations for example multiple optical cameras still and video images. Sensors 310 may include LiDAR which enables the creation of a 3D point cloud of the nearby environment. Sensors 310 may also include RADAR which may provide object and estimated distance to objects and other parts of the terrain near the vehicle. In various embodiments, the 3D environment modeling algorithm 320 receives or creates from raw data any of a point cloud (also known as a range map), a dense point cloud created from stereo camera images, a less dense point cloud created from LiDAR, a list of objects and an estimated distance to that object to help correct the point cloud and provide context of the objects

Vehicles which are autonomous have an array of sensors which may be used for the various embodiments of the navigation system described and in fact may generate the same type of point cloud or other outputs. Eventhough some of the outputs may be the same or similar to that of the autonomous system, the disclosed navigation system may also utilize different information. For example, a 3D geometric model may be combined with other sources of information like the objects in the scene (plants versus trees versus dirt, etc.) to generate a “drivability view”. The drivability view will then be passed to the vehicle's external laser projector that will overlay a laser “picture” of what is drivable and not drivable with the vehicle.

In accordance with various embodiments an input to the algorithm is the 3D range map with the contextual information such as the objects and object types in the scene. Areas that are impossible for the vehicle to access (such as the sky or tops of trees, etc.) may be excluded by the algorithm from the scene. In accordance with various embodiments, a range map with contextual information is processed through a rules-based algorithm that is built through common sense driving rules from expert trial drivers and then is also processed through an AI-based algorithm that is trained on similar 3D range map data that has areas labeled drivable or not drivable by experts. Contextual information includes road surface types, width, and descent/ascent angle, objects such as rocks, fallen trees, plants, overhanging branches, etc. An example rule that would correspond to contextual information is if the road type is sand and it is at a certain level of moisture content, then put a red overlay on that area. Or, if the rock pile in front of the vehicle would require an ascent angle higher than the capability of the vehicle, a red overlay would be put on it. Further, The input data may be formatted into a chosen 3D data format (such as the Open3D format) that is referenced to the vehicle coordinate frame and then “drawn” onto the terrain through the alignment of the laser display coordinate system to the vehicle coordinate frame.

In accordance with various embodiments the input data from the 3D range map with contextual data may be transformed into a 3D range map with data containing drivability parameters, which then may be used for display on the HUD. For the vehicle projection system a 3D range map coded with colors (e.g., red/yellow/green to indicate drivability . . . green being the most drivable) in combination with a grid-like overlay which may be used for coordinating with the laser.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.
The term module, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of module (e.g., at a first time), as a second type of module (e.g., at a second time, which may in some instances coincide with, overlap, or follow a first time), and/or as a third type of module (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first module that has a first purpose, then a second module that has a second purpose and then, a third module that has a third purpose, and so on. The transition of a reconfigurable and/or controllable component may occur in as little as a few nanoseconds, or may occur over a period of minutes, hours, or days.

In some such examples, at the time the component is configured to carry out the second purpose, the component may no longer be capable of carrying out that first purpose until it is reconfigured. A component may switch between configurations as different modules in as little as a few nanoseconds. A component may reconfigure on-the-fly, e.g., the reconfiguration of a component from a first module into a second module may occur just as the second module is needed. A component may reconfigure in stages, e.g., portions of a first module that are no longer needed may reconfigure into the second module even before the first module has finished its operation. Such reconfigurations may occur automatically, or may occur through prompting by an external source, whether that source is another component, an instruction, a signal, a condition, an external stimulus, or similar.

For example, a central processing unit of a personal computer may, at various times, operate as a module for displaying graphics on a screen, a module for writing data to a storage medium, a module for receiving user input, and a module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple modules, the example includes the possibility that the same hardware may implement more than one of the recited modules, either contemporaneously or at discrete times or timings. The implementation of multiple modules, whether using more components, fewer components, or the same number of components as the number of modules, is merely an implementation choice and does not generally affect the operation of the modules themselves. Accordingly, it should be understood that any recitation of multiple discrete modules in this disclosure includes implementations of those modules as any number of underlying components, including, but not limited to, a single component that reconfigures itself over time to carry out the functions of multiple modules, and/or multiple components that similarly reconfigure, and/or special purpose reconfigurable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (for example “configured to”) generally encompass active-state components and/or inactive-state components and/or standby-state components, unless context requires otherwise. While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.” The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software (e.g., a high-level computer program serving as a hardware specification), firmware, or virtually any combination thereof, limited to patentable subject matter under 35 U.S.C. 101. In an embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, limited to patentable subject matter under 35 U.S.C. 101, and that designing the circuitry and/or writing the code for the software (e.g., a high- level computer program serving as a hardware specification) and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.). With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

What is claimed is:

1. A navigation system comprising:
at least one sensor configured to detect terrain and objects near a vehicle;
a processor configured to receive information from the at least one sensor and configured to determine a navigation path for the vehicle to follow; and
a projection system disposable on the vehicle, the projection system being configured to project light onto at least one item chosen from the terrain and the objects based on the determined navigation path.

2. The navigation system of claim 1, wherein the at least one sensor includes at least one sensor chosen from a camera, LiDAR, RADAR, Ultrasound, GPS, an accelerometer, a gyroscopes, a magnetometer and an unmanned aerial vehicle (UAV) mounted sensor.

3. The navigation system of claim 1, wherein the processor is further configured to build a three-dimensional (3D) environment model.

4. The navigation system of claim 3, wherein the processor is further configured to locate the vehicle relative to the three dimensional environment model.

5. The navigation system of claim 3, wherein the 3D environment model includes a 3D Occupancy Grid, a 3D Map for Navigation, and a 3D map for display.

6. The navigation system of claim 1, wherein the processor is configured to generate a map for display having navigation path indicators.

7. The navigation system of claim 1, wherein the processor is configured to generate a map for driving the projection system.

8. The navigation system of claim 1, wherein the processor is configured to generate a map for a head up display (HUD).

9. The navigation system of claim 1, wherein the processor is configured to generate a driving path for an autonomous driving system of the vehicle.

10. A vehicle comprising:
a vehicle body;
at least one wheel coupled to the vehicle body and configured to be driven by at least one motor;
at least one sensor configured to detect terrain and objects near the vehicle;
a processor configured to receive information from the at least one sensor and configured to determine a navigation path for the vehicle to follow;
a projection system disposed on the vehicle, the projection system being configured to project light onto at least one item chosen from the terrain and the objects based on the determined navigation path.

11. The vehicle of claim 10, wherein the at least one sensor includes at least one sensor chosen from a camera, LiDAR, RADAR, Ultrasound, GPS, an accelerometer, a gyroscopes, a magnetometer and an unmanned aerial vehicle (UAV) mounted sensor.

12. The vehicle of claim 10, wherein the processor is further configured to build a three-dimensional (3D) environment model.

13. The vehicle of claim 10, wherein the processor is further configured to locate the vehicle relative to the three dimensional environment model.

14. The vehicle of claim 10, wherein the 3D environment model includes a 3D Occupancy Grid, a 3D Map for Navigation, and a 3D map for display.

15. The vehicle of claim 10, wherein the processor is configured to generate a map for display having navigation path indicators.

16. The vehicle of claim 10, wherein the processor is configured to generate a map for driving the projection system.

17. The vehicle of claim 10, wherein the processor is configured to generate a map for a head up display (HUD).

18. The vehicle of claim 10, wherein the processor is configured to generate a driving path for an autonomous driving system of the vehicle.

19. The vehicle of claim 10, wherein the projection system includes a laser projection system.

20. A method of guiding a vehicle, the method comprising:
receiving, by the vehicle, data from sensors that are configured to detect terrain and objects near the vehicle;
building a navigation map based at least in part on the data;
generating a driveable path for the vehicle based on the navigation map; and
projecting light from the vehicle onto at least one item chosen from the terrain and the objects based on the driveable path.
